(19) United States
(12) Patent Application Publication
(10) Pub. No.: US 2003/0160987 A1
(43) Pub. Date: Aug. 28, 2003

(54) Printing method for using printers to present computerized images on screens and other materials

(76) Inventor: Robert W. Zumbo, Cheyenne, WY (US)

Correspondence Address: Santangelo Law Offices, P.C., Third Floor, 125 South Howes, Fort Collins, CO, 80521, US

(21) Appl. No.: 10/376,831

(22) Filed: Feb. 28, 2003

Related U.S. Application Data
(60) Provisional application No. 60/360,891, filed on Feb. 28, 2002.

(51) Int. Cl. G06F 15/00; B41J 1/00

(52) U.S. Cl. 358/1.9

(57) ABSTRACT

Methods for the use of a printer, such as an ink jet printer, that may be home office in style and size or larger, for application of an electronically stored image such as text or a digitally stored photograph onto a substantially two dimensional medium such as a screen that might be used in a window or door address the need for a convenient, inexpensive means for such printing. Specific techniques regarding application of a type of primer to the printing surface of the print medium in order to enhance adherence of a coloring medium such as paint or ink to the printing surface or medium are presented, as may related techniques for improving the durability and appearance of the completed print. A related internet business method is also contemplated as part of the invention.

### CROSS-REFERENCES TO RELATED APPLICATIONS

This application claims the benefit of and priority from U.S. Provisional Application No. 60/360,891, filed Feb. 28, 2002, entitled “Printing Method and Apparatus for Using Printers to Present Images on Screens And Other Materials”, hereby incorporated by reference.

### BACKGROUND OF THE INVENTION

Generally, this invention relates to a printing method for application of images onto a surface of materials (more generally know as print media) such as screens using printers. More specifically, the invention focuses upon techniques and related apparatus for applying images and/or text saved in computer format (such as digitally photographed pictures or other computerized images, which need not be digital) with an electronic printer such as an ink jet, bubble jet or paint jet printer to print media that such a printer can operate on, such as a nylon or other type screen.

The desire to print electronically stored images such as digital photographs for use in formats other than the usual printed photograph has been known in the printing industry for some time. Certain printing techniques exist for application of such images to, for example, fabric materials such as cotton “t-shirts”. There has not, however, been a technique for printing electronically stored images on nylon mesh screens or other related materials in a manner that is relatively inexpensive and convenient for and readily available to a home user.

The invention offers advantages to consumers who may desire to print images on non-traditional print media such as screens of screen doors or windows, for example, or any other type of screen. Other print media may include fabrics or any material that a printer such as an ink jet printer may operate on. The invention's potential use of a commercially available home office type ink jet printer, or other similar printer, enables consumers to print electronic images relatively inexpensively and in a convenient, comfortable home or office setting, and often with components that are readily available. Techniques for enhancing the appearance of the image as it may be printed on a screen offer obvious visual benefits to any user of the invention's method, including any eventual viewer of the printed image.

### SUMMARY OF THE INVENTION

The present invention includes a variety of aspects which may be selected in different combinations based upon the particular application or needs to be addressed. In one basic form, the invention discloses the use of a printer, such as an ink jet printer, that may be home office in style and size, for application of an electronically stored image (or more generally a computerized image) such as text or a digitally stored photograph onto a substantially two dimensional medium (i.e., a medium with a minimal thickness as compared with length and width dimensions) such as a screen that might be used in a window or door. Specific techniques regarding application of a type of primer to the printing surface of the print medium in order to enhance adherence of a coloring medium such as paint or ink to the printing surface or medium are presented, as may related techniques for improving the durability and appearance of the completed print. A related business method, such as an internet business method, is also considered as part of the invention.

It is an object of the invention to provide a relatively inexpensive technique for printing electronically stored or computerized images on surfaces of materials such as screens and the like for, e.g., aesthetic, decorative, cosmetic or other personal viewing use by a consumer and/or an operator of the printer.

It is an object of the invention to provide a technique for presenting computerized or electronically stored images on surfaces of print media that is durable and that accurately replicates the stored image in a distinct and recognizable fashion.

It is an object of the invention to provide an affordable and convenient method by which to present images in a sunlight-intensive setting such as provided in the vicinity of windows and doors such that the print will interact with light in a manner that is unique and aesthetic.

### BRIEF DESCRIPTION OF THE DRAWINGS

FIG. 1 is a photograph of a screen on which a digital image of a mountain with a lake reflecting it in the foreground has been applied using an ink jet printer.

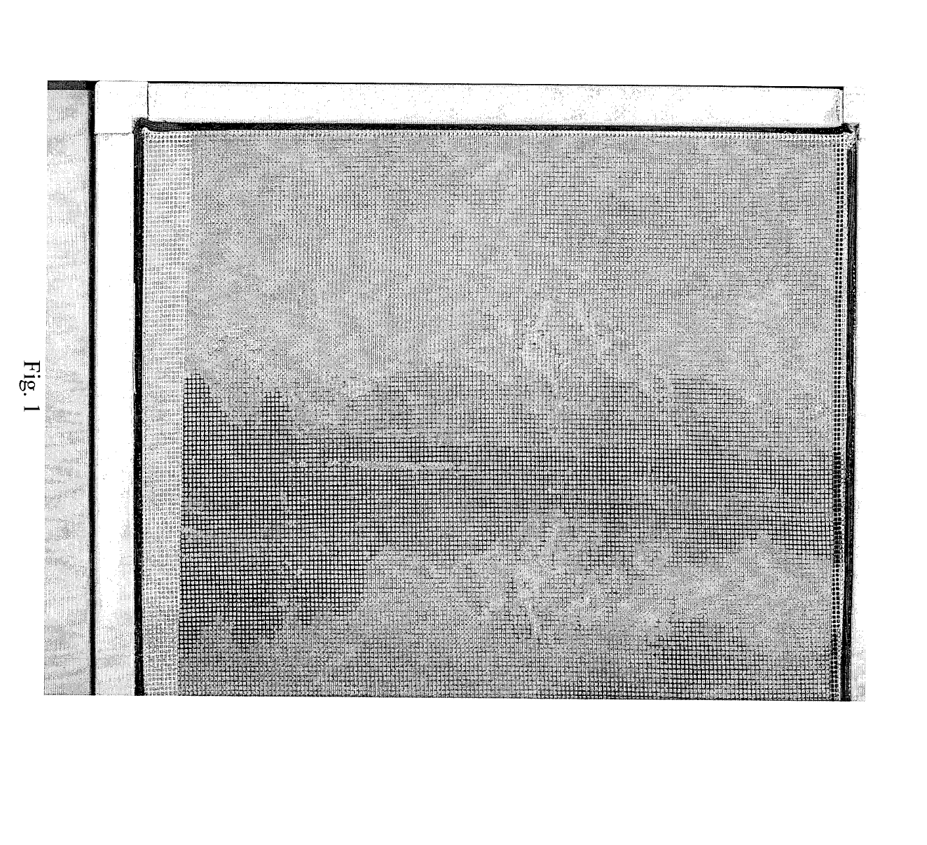

FIG. 2 is a printout of the digital camera generated image used to produce the screen whose photograph is presented in FIG. 1.

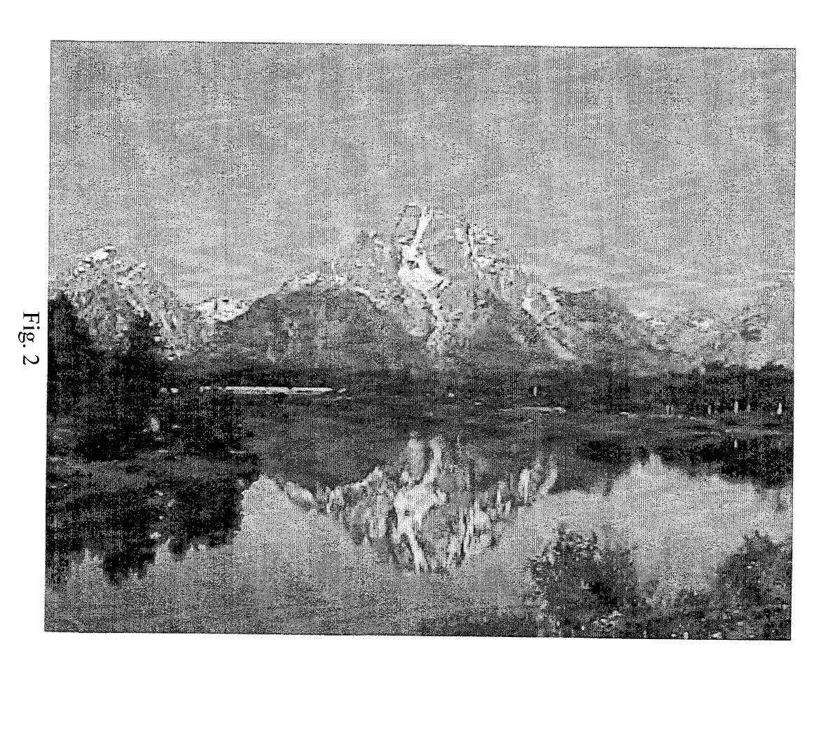

### DETAILED DESCRIPTION OF THE PREFERRED EMBODIMENTS

In a preferred embodiment, a step to be performed before the actual printing may be to obtain a screen, such as a nylon mesh screen, or other print media that may be accepted into a printer such as an ink jet, bubble jet or paint jet printer without damage to either the printer or the print media itself. In order to enhance the appearance of the image, specifically by maximizing the contrast of the colors with respect to one another and the visual environment surrounding the completed print, it may be desirable to color the screen a certain desired base color, such as white or another light color, for example, if it is not already of that desired base color, using what will be referred to as a primer. Note that a primer need not necessarily have the quality and durability enhancing character of many of the commercially available primers that one may, for example, use to prime the underlying surface of a house. Indeed, it need not be what may be commercially referred to as a primer. As used herein, primer refers to any paint, ink or other coloring medium or any color that may be used to color the screen or other print media a certain color before application of the eventual image. It may be that the user desires to use a color other than white or light, such as black, for reasons peculiar to the specific print job and intended eventual location of the completed print. The user may, for appearance and/or durability reasons, choose to prime a surface of the print media even on a surface that is not to be printed directly. Application of the primer may be performed with a brush or other manual applicator, including a power spray paint apparatus. Any other automatic paint or ink applicators that may be available may be used, including but not limited to an ink jet or other type printer, such as a bubble jet or paint jet, as but a few examples. It may be desired, for durability and/or other reasons such as eventual appearance of the completed print, to prime both sides of the print media. One side may be primed one color, and the second another or the same color if desired.

Before any image can be applied to the print media, whether primed or not, it may be necessary for a user to obtain access to a printer, such as, but not limited to a home office ink jet printer. It may also be necessary to generate a computerized image so as to have an image that exists in a computer format that may be readable by an electronic printer such as an ink jet printer. This may be done by, e.g., taking a photograph with a digital camera or other digital photographing device (each of which is deemed to include a computer) or taking a photograph with a traditional film camera (such as 35 mm film), developing the film, and then scanning the developed photograph into computer format using a scanner so that the digital photograph becomes a computerized image. Any other generation of images into computer format, or conversion into computer format, in any manner, including also non-photographic generation through the use of, e.g., computer software such as PaintShop, is contemplated by the invention.

Of course, it is necessary to obtain (merely meaning gain access to) a printer at some time before the actual printing. Such printer may be electronically responsive to a computer, meaning it is possible to electronically communicate information (such as information defining a computerized image) to the printer using the computer. It is important to also note that computer includes not only personal computers, but also computing apparatus that form a part of digital cameras and other microprocessor-based devices and assemblies that are capable of electronically acting on certain input, even if only by storing said input in an electronic (such as digital) form.

Once any primer that may have been applied (again, an optional step) has dried, the next step may be to establish (e.g., as by securing) a paint block element such as a piece of paper (that may be of similar size to the print medium that is to be passed through the printer) on the side of the print medium that is opposite the side to be printed on in order to prevent any ink or paint that may pass through the screen from being deposited onto internal printer parts and possibly causing later malfunction of the printer. Certain properties or settings of the printer, such as resolution and color capability may be adjusted as desired (note, again, that the colors used may include black and white, in addition to any other colors). The screen or other medium may then be “fed” into the printer after a print command, perhaps using an electronically attached or electronically responsive computer such as a personal computer, is entered, thereby instructing the printer to print the desired image. Before this “feeding” step occurs (or perhaps as part of this feeding step), what may be referred to as the step of establishing a print medium such as a nylon mesh (or other type) screen so that the printer may print on the print medium may be performed. This step of “establishing” includes any manner of successfully delivering print media to the printer for use by the printer, whether it be placing the print medium in the printer for manual feed printing or placing print media in a tray for automatic retrieval by the printer. The actual acceptance of the print medium by the computer (whereupon the print medium is taken into the printer in some fashion) may occur upon execution of the print command or immediately upon placement of the print media in a manual feed position. The printer (upon command if necessary) will then print the electronically stored or computerized image on the print medium (such as a screen). Of course, before this step, there must take place a communication of the If desired, the print may then be placed in a reverse orientation for printing on the opposite side of the print. If this opposite side has not yet been primed and such step is desired, then that step may take place prior to feeding the print through in a reverse orientation. For image printing on this opposite side, it may be necessary to send a second print command corresponding to the same or a different image, as may be desired.

Once the ink has dried, it may be desired to apply a protective coating of sealant such as lacquer or spray to whichever side of print medium has been printed (or merely primed) in order to protect the completed print from weathering forces. It may also be desired additionally to protect any side or portion that has not been printed on. Note that this lacquer (or other protective sealant) coating may be less necessary (perhaps even unnecessary) if the coloring medium (e.g., the paint or ink) is acrylic-based (referred to merely as acrylic) or other coloring media type that “self seals”. Further, priming may be less necessary (or perhaps even unnecessary) if the coloring medium is acrylic-based. Thus, using non-acrylic inks or paints may be less desirable than using acrylic inks or paints (although it is still deemed part of the inventive subject matter), as use of such non-acrylic coloring media may require the additional steps of priming and/or lacquer application. The completed print may then be placed wherever desired; if the medium is screening, then the screening may be inserted into, for example, a screen window frame or a screen door frame, or as a rollable hanging screen. It is important to realize that the printed screen is considered a part of the inventive subject matter, regardless which inventive method is used to create it.

The invention also contemplates the possibility of application in other fields such as perhaps a type of billboard printing or large-scale print application that may incorporate nontraditional media such as screening. Printers that may be used to generate such prints may be industrial printers, including industrial wide-format printers. Any size screening that portrays any image printed using a computer or other printer need not only be placed in a window or door, as there exists potential for large scale outdoor, free hanging display, for example.

Related to the above-described method is a business method by which customers may submit photos or other text for printing via, for example, the internet. Specifics regarding the desired order such as size, color, etc., may be provided to a printer by the consumer also via the internet. Printing may be performed at a centralized location from which completed prints may be shipped for at home delivery to the consumer. At least one embodiment of such a business method may comprise the steps of communicating (e.g., advertising in any manner) a printing service to a potential customer group (the general public, homeowners, computer enthusiasts, and/or photographers, as but a few examples); receiving a computerized image from a customer (via the internet, which is defined to includes email, as but a few examples); printing said computerized image on a nylon mesh screen to create a printed screen; and shipping or sending (via the postal service or a private shipping service, for example) said printed screen to said customer. Of course, customer is intended to include anyone who uses the printing service by, e.g., submitting in any manner a computerized image.

Note also that in a preferred embodiment of the business method invention, the step of receiving the computerized image from a customer is accomplished via the internet (e.g., the customer may email the computerized image to a certain email address or website; or submit the image via any other electronic communication medium that may be available), but, in at least one other embodiment, the step of receiving the computerized image from a customer may also be accomplished via physical submission of a computerized data storage medium (on which is stored the computerized image(s) to be printed) to a certain mailing address corresponding to service operator(s) or service provider(s).

Further, the step of printing the computerized image on a nylon mesh screen to create a printed screen may comprise any or all of the steps that relate to the actual printing process as described above. In such a case, the definition of generating a computerized image may be expanded to include the step of receiving a computerized image from a customer.

Further, the business method may include the step of cosmetically enhancing the computerized image before performing said step of printing the computerized image on a nylon mesh screen to create a printed screen. This step of cosmetically enhancing may be performed through the use of any of the available image-editing software packages (e.g., PhotoShop®)). In such embodiment(s), the step of converting said non-computerized image into a digital format image may comprise the step of generating a computerized image.

At least one embodiment of a business method invention that is somewhat related to the above disclosed business methods involves the receipt of a non-computerized image from a customer; and then subsequent conversion of that non-computerized image into digital form for use by a printer that is responsive to a computer.

As can be easily understood from the foregoing, the basic concepts of the present invention may be embodied in a variety of ways. It involves both printing techniques as well as devices to accomplish the appropriate printing. In this application, the printing techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this non-provisional application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims which will be included in a full patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon by the claims for this full patent application. This full patent application will seek examination of as broad a base of claims as deemed within the applicant's right and is designed to yield a patent covering numerous aspects of the invention both independently and as an overall system.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “printer” should be understood to encompass disclosure of the act of “printing”—whether explicitly discussed or not—and, conversely, where there effectively is disclosure of the act of “printing”, such a disclosure should be understood to encompass disclosure of a “print” and even a “means for printing.” Such changes and alternative terms are to be understood to be explicitly included in the description.

Any acts of law, statutes, regulations, or rules mentioned in this application for patent; or patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Patent Application or other information disclosure statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim at least: i) each of the printing devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, and ix) methods and apparatuses substantially as described hereinbefore and with reference to any of the accompanying examples, x) the various combinations and permutations of each of the elements disclosed, xi) each potentially dependent claim or concept as a dependency on each and every one of the independent claims or concepts presented, xii) processes performed with the aid of or on a computer as described throughout the above discussion, xiii) a programmable apparatus as described throughout the above discussion, xiv) a computer readable memory encoded with data to direct a computer comprising means or elements which function as described throughout the above discussion, xv) a computer configured as herein disclosed and described, xvi) individual or combined subroutines and programs as herein disclosed and described, xvii) the related methods disclosed and described, xviii) similar, equivalent, and even implicit variations of each of these systems and methods, xvix) those alternative designs which accomplish each of the functions shown as are disclosed and described, xx) those alternative designs and methods which accomplish each of the functions shown as are implicit to accomplish that which is disclosed and described, xxi) each feature, component, and step shown as separate and independent inventions, and xxii) the various combinations and permutations of each of the above. In this regard it should be understood that for practical reasons and so as to avoid adding potentially hundreds of claims, the applicant may eventually present claims with initial dependencies only. Support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

The claims set forth in this specification by are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

What is claimed is:

1. A method for printing a computerized image on a nylon mesh screen, said method comprising the steps of:
generating a computerized image;
obtaining a printer electronically responsive to a computer;
establishing a nylon mesh screen so that said printer may print on said nylon mesh screen;
communicating said computerized image to said printer; and
printing said computerized image on said nylon mesh screen to create a printed screen.

2. A method for printing a computerized image on a nylon mesh screen as described in claim 1, wherein said step of generating a computerized image comprises the step of generating a digital image.

3. A method for printing a computerized image on a nylon mesh screen as described in claim 3, wherein said step of generating a digital image comprises the step of generating a digital photograph.

4. A method for printing a computerized image on a nylon mesh screen as described in claim 1, wherein said step of obtaining a printer responsive to a computer comprises the step of obtaining a paint jet printer.

5. A method for printing a computerized image on a nylon mesh screen as described in claim 1, wherein said step of obtaining a printer responsive to a computer comprises the step of obtaining an ink jet printer.

6. A method for printing a computerized image on a nylon mesh screen as described in claim 1, wherein said step of obtaining a printer responsive to a computer comprises the step of obtaining a bubble jet printer.

7. A method for printing a computerized image on a nylon mesh screen as described in claim 4, wherein said step of obtaining a paint jet printer responsive to a computer comprises the step of obtaining an industrial printer.

8. A method for printing a computerized image on a nylon mesh screen as described in claim 7, wherein said step of obtaining an industrial printer responsive to a computer comprises the step of obtaining an industrial wide format printer.

9. A method for printing a computerized image on a nylon mesh screen as described in claim 5, wherein said step of obtaining an ink jet printer responsive to a computer comprises the step of obtaining a home office printer.

10. A method for printing a computerized image on a nylon mesh screen as described in claim 6, wherein said step of obtaining a bubble jet printer responsive to a computer comprises the step of obtaining a home office printer.

11. A method for printing a computerized image on a nylon mesh screen as described in claim 1, wherein said step of obtaining a printer responsive to a computer comprises the step of obtaining a printer that is adapted to use acrylic paint.

12. A method for printing a computerized image on a nylon mesh screen as described in claim 1, wherein said step of obtaining a printer responsive to a computer comprises the step of obtaining a printer that is adapted to use acrylic ink.

13. A method for printing a computerized image on a nylon mesh screen as described in claim 1 wherein said step of printing said computerized image on said nylon mesh screen comprises the step of printing with a non-acrylic ink.

14. A method for printing a computerized image on a nylon mesh screen as described in claim 1 wherein said step of printing said computerized image on said nylon mesh screen comprises the step of printing with a non-acrylic paint.

15. A method for printing a computerized image on a nylon mesh screen as described in claim 13 further comprising the step of applying a sealant to said printed screen.

16. A method for printing a computerized image on a nylon mesh screen as described in claim 14 further comprising the step of applying a sealant to said printed screen.

17. A method for printing a computerized image on a nylon mesh screen as described in claim 1 further comprising the step of priming said nylon mesh screen before performing said step of establishing a nylon mesh screen so that said printer may print on said nylon mesh screen.

18. A method for printing a computerized image on a nylon mesh screen as described in claim 13 further comprising the step of priming said nylon mesh screen before performing said step of establishing a nylon mesh screen so that said printer may print on said nylon mesh screen.

19. A method for printing a computerized image on a nylon mesh screen as described in claim 14 further comprising the step of priming said nylon mesh screen before performing said step of establishing a nylon mesh screen so that said printer may print on said nylon mesh screen.

20. A method for printing a computerized image on a nylon mesh screen as described in claim 15 further comprising the step of priming said nylon mesh screen before performing said step of establishing a nylon mesh screen so that said printer may print on said nylon mesh screen.

21. A method for printing a computerized image on a nylon mesh screen as described in claim 16 further comprising the step of priming said nylon mesh screen before performing said step of establishing a nylon mesh screen so that said printer may print on said nylon mesh screen.

22. A method for printing a computerized image on a nylon mesh screen as described in claim 1 wherein said printed screen is usable in a home window.

23. A method for printing a computerized image on a nylon mesh screen as described in claim 1 wherein said printed screen is usable in a home door.

24. A method for printing a computerized image on a nylon mesh screen as described in claim 1 wherein said printed screen is usable as a rollable hanging screen

25. A method for printing a computerized image on a nylon mesh screen as described in claim 1 further comprising the step of establishing a paint block element on the side of the print medium that is opposite the side to be printed on.

26. The printed screen of claim 1.

27. A business method comprising the steps of:
communicating a printing service to a potential customer group;
receiving a computerized image from a customer;
printing said computerized image on a nylon mesh screen to create a printed screen; and
sending said printed screen to said customer.

28. A business method as described in claim 27 wherein said step of receiving a computerized image from a customer is accomplished via the internet.

29. A business method as described in claim 27 wherein said step of printing said computerized image on a nylon mesh screen to create a printed screen comprises the steps described in claim 1.

30. A business method as described in claim 27 further comprising the step of cosmetically enhancing said computerized image before performing said step of printing said computerized image on a nylon mesh screen to create a printed screen.

31. A business method as described in claim 30 wherein said step of cosmetically enhancing said computerized image comprises the step of cosmetically enhancing through the use of image editing computer software.

32. A business method as described in claim 27 wherein said step of printing said computerized image on a nylon mesh screen to create a printed screen comprises the steps described in claim 3.

33. A business method as described in claim 27 wherein said step of printing said computerized image on a nylon mesh screen to create a printed screen comprises the steps described in claim 7.

34. A business method as described in claim 29 wherein said step of generating a computerized image comprises said step of receiving a computerized image from a customer.

35. The printed screen of claim 27.

36. A business method comprising the steps of:
communicating a printing service to a potential customer group;
receiving a non-computerized image from a customer;
converting said non-computerized image into a digital format image
printing said digital format image on a nylon mesh screen to create a printed screen; and
sending said printed screen to said customer.

37. A business method as described in claim 36 wherein said step of printing said digital format image on a nylon mesh screen to create a printed screen comprises the steps described in claim 1.

38. A business method as described in claim 37 wherein said step of converting said non-computerized image into a digital format image comprises said step of generating a computerized image.

39. A business method as described in claim 36 further comprising the step of cosmetically enhancing said digital format image before performing said step of printing said digital format image on a nylon mesh screen to create a printed screen.

40. A business method as described in claim 39 wherein said step of cosmetically enhancing said computerized image comprises the step of cosmetically enhancing through the use of image editing computer software.

41. The printed screen of claim 36.
